(19) United States
(12) Patent Application Publication
(10) Pub. No.: US 2019/0363435 A1
(43) Pub. Date: Nov. 28, 2019

(54) DECOUPLING CIRCUIT

(71) Applicant: Mitsubishi Electric Corporation, Tokyo (JP)

(72) Inventors: Hidetoshi MAKIMURA, Tokyo (JP); Kengo NISHIMOTO, Tokyo (JP); Yasuhiro NISHIOKA, Tokyo (JP)

(73) Assignee: Mitsubishi Electric Corporation, Tokyo (JP)

(21) Appl. No.: 16/478,101

(22) PCT Filed: Feb. 8, 2017
(86) PCT No.: PCT/JP2017/004541

§ 371 Date: Jul. 15, 2019

(51) Int. Cl. H01Q 1/52; H01Q 3/26; H04B 1/10; H04B 1/12

(52) U.S. Cl. CPC H01Q 1/521; H04B 1/126; H04B 1/1027; H01Q 3/26

(57) ABSTRACT

It is provided with: a variable decoupling circuit (10) connected to a first input/output port (1) and a third input/output port (3), which reduces coupling between the first input/output port (1) and the third input/output port (3); and a coupling measurement circuit (20) that measures a coupled amplitude and a coupled phase between a second input/output port and a fourth input/output port from a signal output from the variable decoupling circuit (10) to the second input/output port when a signal is input from the first input/output port (1) and a signal output from the fourth input/output port to the variable decoupling circuit (10) when a signal is input from the fourth input/output port, in which a controller (30) controls the variable decoupling circuit (10) in accordance with the coupled amplitude and the coupled phase measured by the coupling measurement circuit (20) such that a coupled amplitude between the first input/output port (1) and the third input/output port (3) becomes zero.

### TECHNICAL FIELD

The present invention relates to a decoupling circuit that reduces coupling between a plurality of input/output ports.

### BACKGROUND ART

In recent years, a communication terminal such as a smartphone may support a plurality of communication schemes.

For example, a communication terminal may support a communication scheme using Bluetooth (registered trademark; this indication will be omitted hereinafter) and a communication scheme using a wireless local area network (LAN) in a 2.4 GHz band, and may be capable of performing wireless communication independently using two communication schemes.

Bluetooth is a short-range wireless communication technology standardized by the Institute of Electrical and Electronic Engineers (IEEE).

When a communication terminal performs wireless communication independently using two communication schemes, a signal of wireless communication in one communication scheme may become nothing more than noise for wireless communication in the other communication scheme, thereby deteriorating communication quality.

Therefore, in order to suppress the deterioration in communication quality in two communication schemes, for example, coupling between an antenna for wireless communication using Bluetooth and an antenna for wireless communication using a wireless LAN needs to be suppressed.

Further, when diversity and multiple input multiple output (MIMO) are applied in response to the demand for speeding up and improving quality of wireless communication, a plurality of antennas may be used. In order to fully exert the effects of diversity and MIMO, it is necessary to minimize coupling between multiple antennas to lower the correlation of the multiple antennas.

In general, an interval between the multiple antennas is required to be sufficiently long to suppress coupling between the multiple antennas. However, in the case where a communication terminal is a small terminal, the area in which an antenna can be mounted is small, whereby it is likely that the interval between the multiple antennas is difficult to be sufficiently long.

Patent Literature 1 set out below discloses a wireless communication device including a decoupling circuit to reduce coupling between multiple antennas, which aims to suppress coupling between the multiple antennas even in the case where the interval between the multiple antennas is difficult to be sufficiently long.

This decoupling circuit includes a variable reactance circuit between two antennas, and has a function of switching a reactance value of the variable reactance circuit at regular time intervals.

When the reactance value switched at regular time intervals is a value adapted to the usage environment of the wireless communication device, coupling between the multiple antennas can be suppressed.

For switching of the reactance value at regular time intervals, a plurality of reactance elements is prepared in advance, and a reactance element to be used is selected from the plurality of reactance elements depending on the usage environment.

### CITATION LIST

### Patent Literatures

Patent Literature 1: JP 2011-109440 A

### SUMMARY OF INVENTION

### Technical Problem

Since the conventional decoupling circuit is configured as described above, when the number of reactance elements prepared in advance is large, the possibility of selecting the reactance value adapted to the usage environment of the wireless communication device increases. However, as the number of reactance elements prepared in advance increases, a processing load increases, and it may take more time to select a reactance element to be used.

On the other hand, there has been a problem that, when the number of reactance elements prepared in advance is small, the possibility of selecting the reactance value adapted to the usage environment of the wireless communication device decreases and coupling between a plurality of antennas cannot be sufficiently suppressed in some cases.

The present invention has been conceived to solve the problems as described above, and an object of the present invention is to provide a decoupling circuit capable of suppressing coupling between a plurality of input/output ports without executing processing of selecting a reactance element to be used from a large number of reactance elements.

### Solution to Problem

A decoupling circuit according to the present invention includes: a variable decoupling circuit to reduce coupling between a first input/output port and a third input/output port, which is connected to each of the first input/output port and the third input/output port; and a coupling measurement circuit to measure a coupled amplitude and a coupled phase between a second input/output port and a fourth input/output port from a signal output from the variable decoupling circuit to the second input/output port when a signal is input from the first input/output port and a signal output from the fourth input/output port to the variable decoupling circuit when a signal is input from the fourth input/output port, and a controller controls the variable decoupling circuit in accordance with the coupled amplitude and the coupled phase measured by the coupling measurement circuit such that a coupled amplitude between the first input/output port and the third input/output port becomes zero.

### Advantageous Effects of Invention

According to the present invention, it is provided with: a variable decoupling circuit to reduce coupling between a first input/output port and a third input/output port, which is connected to each of the first input/output port and the third input/output port; and a coupling measurement circuit to measure a coupled amplitude and a coupled phase between a second input/output port and a fourth input/output port from a signal output from the variable decoupling circuit to the second input/output port when a signal is input from the first input/output port and a signal output from the fourth input/output port to the variable decoupling circuit when a signal is input from the fourth input/output port, and a controller controls the variable decoupling circuit in accordance with the coupled amplitude and the coupled phase measured by the coupling measurement circuit such that a coupled amplitude between the first input/output port and the third input/output port becomes zero, whereby an effect of being capable of suppressing coupling between the first input/output port and the third input/output port is exerted without executing processing of selecting a reactance element to be used from a large number of reactance elements.

### BRIEF DESCRIPTION OF DRAWINGS

FIG. 1 is a configuration diagram illustrating a decoupling circuit according to a first embodiment of the present invention.

FIG. 2 is a configuration diagram illustrating a coupling measurement circuit 20 of the decoupling circuit according to the first embodiment of the present invention.

FIG. 3 is a configuration diagram illustrating a decoupling circuit according to a second embodiment of the present invention.

FIG. 4 is a configuration diagram illustrating another decoupling circuit according to the second embodiment of the present invention.

FIG. 5 is an explanatory graph illustrating a change in |pₒᵤₜ| in the case where a coupling degree Cₚ=0.01, a coupled amplitude α=0.1, and a coupled phase φ=π/2.

FIG. 6 is a configuration diagram illustrating a decoupling circuit according to a third embodiment of the present invention.

FIG. 7 is a configuration diagram illustrating a coupling measurement circuit 20 of a decoupling circuit according to a fourth embodiment of the present invention.

FIG. 8 is a configuration diagram illustrating a variable decoupling circuit 10 of a decoupling circuit according to a fifth embodiment of the present invention.

### DESCRIPTION OF EMBODIMENTS

Hereinafter, embodiments of the present invention will be described to explain the present invention in more detail with reference to the accompanying drawings.

### First Embodiment

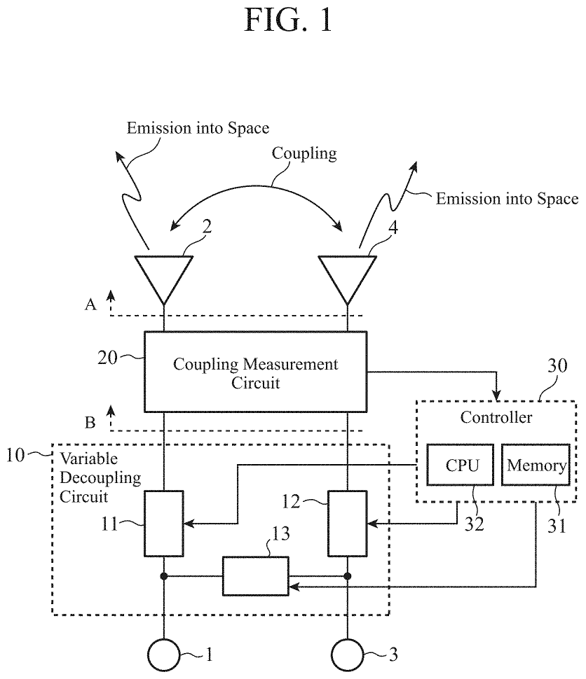

FIG. 1 is a configuration diagram illustrating a decoupling circuit according to a first embodiment of the present invention.

In FIG. 1, a first input/output port 1 is an input/output port for inputting/outputting a signal.

A second input/output port for inputting/outputting a signal is an antenna 2.

A third input/output port 3 is an input/output port for inputting/outputting a signal.

A fourth input/output port for inputting/outputting a signal is an antenna 4.

In the first embodiment, a high-frequency signal is input from the first input/output port 1, and a radio wave, which is a high-frequency signal, is emitted from the antenna 2 into space.

Therefore, an exemplary case where the antenna 4 receives a part of the radio wave emitted from the antenna 2 and the third input/output port 3 outputs a high-frequency signal will be described.

In this case, the antenna 4 can also be used as a transmission antenna for emitting a radio wave, which is a high-frequency signal, into space, FIG. 1 illustrates a state in which the antenna 4 emits a radio wave.

Although an exemplary case where the second and fourth input/output ports are the antennas 2 and 4 is described in the first embodiment, it is not limited to this case, and for example, the second and fourth input/output ports may be circuit boards or the like.

A variable decoupling circuit 10 includes a first variable reactance circuit 11, a second variable reactance circuit 12, and a third variable reactance circuit 13.

The variable decoupling circuit 10, which is connected to each of the first input/output port 1 and the third input/output port 3, is a circuit for reducing coupling between the first input/output port 1 and the third input/output port 3.

The first variable reactance circuit 11 is a variable reactance circuit in which one end thereof is connected to the first input/output port 1 and the other end thereof is connected to the antenna 2 via a coupling measurement circuit 20.

The second variable reactance circuit 12 is a variable reactance circuit in which one end thereof is connected to the third input/output port 3 and the other end thereof is connected to the antenna 4 via the coupling measurement circuit 20.

The third variable reactance circuit 13 is a variable reactance circuit in which one end thereof is connected to the first input/output port 1 and the other end thereof is connected to the third input/output port 3.

The first variable reactance circuit 11, the second variable reactance circuit 12, and the third variable reactance circuit 13 are required to be capable of taking both an inductive reactance value and a capacitive reactance value.

Examples of a general circuit configuration of such a variable reactance circuit include a configuration in which a distributed constant element and a lumped constant element having a fixed reactance value are switched using a physical switch such as a relay or an electrical switch of a semiconductor. However, in the case of this circuit configuration, a controller 30 for controlling the first variable reactance circuit 11, the second variable reactance circuit 12, and the third variable reactance circuit 13 is required to execute processing for selecting a lumped constant element or a distributed constant element to be used from among a large number of lumped constant elements or distributed constant elements. In view of the above, this circuit configuration is not intended for the first embodiment.

In the first embodiment, a configuration in which a first circuit including an inductor having a fixed reactance value and a capacitor having a fixed reactance value and a second circuit including an inductor having a variable reactance value and a capacitor having a variable reactance value are connected in parallel or in series is intended for the circuit configuration of the first variable reactance circuit 11, the second variable reactance circuit 12, and the third variable reactance circuit 13.

Accordingly, the controller 30 can switch the reactance value of the first variable reactance circuit 11, the second variable reactance circuit 12, and the third variable reactance circuit 13 between inductive and capacitive values without executing the processing for selecting a reactance element to be used from among a large number of reactance elements.

In addition, control amounts of the first variable reactance circuit 11, the second variable reactance circuit 12, and the third variable reactance circuit 13 become one, thereby reducing a processing load on the controller 30.

Although a case where the first circuit and the second circuit are connected in parallel or in series in the first variable reactance circuit 11, the second variable reactance circuit 12, and the third variable reactance circuit 13 is exemplified here, the circuit configurations of the first circuit and the second circuit are not limited to the example above. For example, among the inductor and the capacitor included in the first circuit, the inductor having a fixed reactance value may be replaced with an inductor having a variable reactance value. Alternatively, the capacitor having a fixed reactance value may be replaced with a capacitor having a variable reactance value.

The coupling measurement circuit 20 is a circuit for measuring a coupled amplitude α and a coupled phase φ between the antenna 2 and the antenna 4 from a high-frequency signal output from the variable decoupling circuit 10 to the antenna 2 when a high-frequency signal is input from the first input/output port 1 and a high-frequency signal output from the antenna 4 to the variable decoupling circuit 10 when a radio wave, which is a high-frequency signal, is input from the antenna 4.

The controller 30 includes a memory 31, and a central processing unit (CPU) 32.

The controller 30 controls the variable decoupling circuit 10 such that the coupled amplitude between the first input/output port 1 and the third input/output port 3 becomes zero in accordance with the coupled amplitude α and the coupled phase φ measured by the coupling measurement circuit 20.

The memory 31 of the controller 30 stores a table indicating a correspondence relationship between the coupled amplitude α and the coupled phase φ between the antenna 2 and the antenna 4 and reactance values of the first variable reactance circuit 11, the second variable reactance circuit 12, and the third variable reactance circuit 13.

The CPU 32 of the controller 30 refers to the table stored in the memory 31, and obtains reactance values of the first variable reactance circuit 11, the second variable reactance circuit 12, and the third variable reactance circuit 13 corresponding to the coupled amplitude α and the coupled phase φ measured by the coupling measurement circuit 20.

The CPU 32 controls the reactance values of the variable reactance circuits 11 to 13 such that the reactance values of the first variable reactance circuit 11, the second variable reactance circuit 12, and the third variable reactance circuit 13 become the obtained reactance values.

Although an exemplary case where the CPU 32 refers to the table stored in the memory 31 and obtains reactance values will be described in the first embodiment, the CPU 32 may use the following formulae (2) and (3) or formulae (4) and (5) to calculate the reactance values.

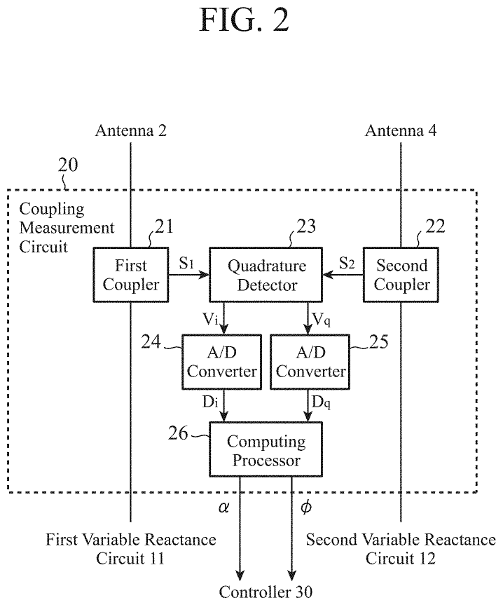

FIG. 2 is a configuration diagram illustrating the coupling measurement circuit 20 of the decoupling circuit according to the first embodiment of the present invention.

In FIG. 2, a first coupler 21 is implemented by, for example, a Wilkinson power distributor, a directional coupler, or the like, and extracts a part of the high-frequency signal output from the variable reactance circuit 11 of the variable decoupling circuit 10 to output the extracted high-frequency signal S₁ to a quadrature detector 23.

A second coupler 22 is implemented by, for example, a Wilkinson power distributor, a directional coupler, or the like, and extracts a part of the high-frequency signal output from the antenna 4 to output the extracted high-frequency signal S₂ to the quadrature detector 23.

In the case where the first coupler 21 and the second coupler 22 are implemented by directional couplers, even if transmission and reception of the antenna 2 and the antenna 4 are switched, a part of the high-frequency signal can be extracted. Therefore, in the case of a communication device in which transmission and reception of the antenna 2 and the antenna 4 dynamically change, it is not necessary to provide a coupler for transmission and a coupler for reception for one antenna, whereby the circuit scale can be reduced.

The quadrature detector 23 is a circuit that may be referred to as an IQ detector, which is a circuit including, for example, a mixer, a phase shifter, a distributor, a detector, and the like.

The quadrature detector 23 detects an I component (in-phase component) and a Q component (quadrature component) from the high-frequency signal S₁ that is an output signal of the first coupler 21 and the high-frequency signal S₂ that is an output signal of the second coupler 22, and outputs a DC voltage Vᵢ indicating the I component and a DC voltage V_{q} indicating the Q component.

An A/D converter 24 is an analog-digital converter that converts the DC voltage Vᵢ output from the quadrature detector 23 from an analog signal to a digital signal Dᵢ and outputs the digital signal Dᵢ to a computing processor 26.

An A/D converter 25 is an analog-digital converter that converts the DC voltage V_{q} output from the quadrature detector 23 from an analog signal to a digital signal D_{q} and outputs the digital signal D_{q} to the computing processor 26.

The computing processor 26 computes the coupled amplitude α and the coupled phase φ between the antenna 2 and the antenna 4 from the digital signal Dᵢ output from the A/D converter 24 and the digital signal D_{q} output from the A/D converter 25, and outputs the coupled amplitude α and the coupled phase φ to the controller 30.

Although a case where the coupling measurement circuit 20 includes the computing processor 26 is exemplified here, for example, the CPU 32 of the controller 30 may have a computing function of the computing processor 26, and the CPU 32 may compute the coupled amplitude α and the coupled phase φ.

Moreover, one or both of the A/D converter 24 and the A/D converter 25 may be incorporated in a part of the computing processor 26 or the controller 30.

Next, operation will be described.

In the first embodiment, description will be made on the assumption that a transmitter is connected to the first input/output port 1 and a receiver is connected to the third input/output port 3.

In this case, when high-frequency signal output from the transmitter are applied to the first input/output port 1, the high-frequency signal is emitted from the antenna 2 into space as a radio wave, and a part of the radio wave is received by the antenna 4. The high-frequency signal, which is the radio wave received by the antenna 4, is transmitted to the third input/output port 3 as a coupling signal.

In the first embodiment, the antenna 2 is assumed to be matched with the impedance of the first input/output port 1. In addition, the antenna 4 is assumed to be matched with the impedance of the third input/output port 3.

A ratio between a signal input from a reference surface A to the antenna 2 and a signal input from the antenna 4 to the reference surface A is represented by S₂₁.

S₂₁=α×exp(jφ) (1)

In formula (1), α represents a coupled amplitude, φ represents a coupled phase, and j represents an imaginary unit.

For example, at the time of manufacturing the decoupling circuit of FIG. 1, a table is created, and the table is stored in the memory 31 of the controller 30.

That is, the decoupling circuit of FIG. 1 creates a table indicating a correspondence relationship between the coupled amplitude α and the coupled phase φ between the antenna 2 and the antenna 4 and the reactance values of the first variable reactance circuit 11, the second variable reactance circuit 12, and the third variable reactance circuit 13, and the table is stored in the memory 31 of the controller 30.

Hereinafter, an example of creating the table will be described.

For example, at the time of manufacturing the decoupling circuit of FIG. 1, the transmitter applies a test signal to the first input/output port 1, and the coupling measurement circuit 20 measures the coupled amplitude α and the coupled phase φ.

The CPU 32 of the controller 30 stores the coupled amplitude α and the coupled phase φ measured by the coupling measurement circuit 20 in the table in the memory 31.

Next, the CPU 32 performs control of switching the reactance values of the first variable reactance circuit 11, the second variable reactance circuit 12, and the third variable reactance circuit 13 in accordance with a preset procedure while monitoring the coupled amplitude α and the coupled phase φ measured by the coupling measurement circuit 20.

At this time, in accordance with the coupled amplitude α and the coupled phase y measured by the coupling measurement circuit 20, the CPU 32 searches for reactance values of the first variable reactance circuit 11, the second variable reactance circuit 12, and the third variable reactance circuit 13 at which the coupled amplitude between the first input/output port 1 and the third input/output port 3 becomes zero.

After searching for the reactance value at which the coupled amplitude between the first input/output port 1 and the third input/output port 3 becomes zero, the CPU 32 stores the searched reactance value in the table in the memory 31 as a reactance value corresponding to the coupled amplitude α and the coupled phase φ previously stored in the table in the memory 31.

A process in which the transmitter applies a plurality of test signals to the first input/output port 1 to search for a reactance value at which the coupled amplitude between the first input/output port 1 and the third input/output port 3 becomes zero is repeatedly executed.

As a result, it is possible to create a table indicating a correspondence relationship between the coupled amplitude α and the coupled phase φ and the reactance values of the first variable reactance circuit 11, the second variable reactance circuit 12, and the third variable reactance circuit 13.

Under the condition in which the coupled amplitude between the first input/output port 1 and the third input/output port 3 becomes zero, the coupling seen from the first input/output port 1 to the third input/output port 3 becomes zero.

At this time, the coupling seen from the first input/output port 1 to the third input/output port 3 is equal to the coupling seen from the third input/output port 3 to the first input/output port 1. Therefore, the table mentioned described above can be used not only when the transmitter is connected to the first input/output port 1 and the receiver is connected to the third input/output port 3, but also when the transmitter is connected to the third input/output port 3 and the receiver is connected to the first input/output port 1.

Although an exemplary case where the table is created at the time of manufacturing the decoupling circuit of FIG. 1 is described here, creation of the table may be executed at regular time intervals. Further, the creation of the table may be triggered by, for example, information from a sensor capable of observing environmental fluctuations around the antenna, such as a change in vibration. This makes it possible to maintain a state in which the coupling between two antennas is constantly reduced even if the environment around the antennas changes.

If the passing loss and the passing phase shift amount at the time when the high-frequency signal passes through the coupling measurement circuit 20 can be reduced to such an extent that the coupling signal at the reference surface A and the coupling signal at the reference surface B can be regarded as identical, a susceptance value B₁ at which the coupled amplitude between the first input/output port 1 and the third input/output port 3 becomes zero is expressed by the following formula (2). The susceptance value B₁ is the reciprocal of the reactance value in the first variable reactance circuit 11 and the second variable reactance circuit 12.

B₁=Y₀(sin ϕ±1)/cos ϕ (2)

Further, a susceptance value B₂, which is the reciprocal of the reactance value in the third variable reactance circuit 13 at which the coupled amplitude between the first input/output port 1 and the third input/output port 3 becomes zero, is expressed by the following formula (3).

$${B}_{2} = - \frac{α {Y}_{0} ( sin φ \pm 1 )}{1 + {α}^{2}} \qquad ( 3 )$$

In formulae (2) and (3), Y₀ represents a normalized admittance.

Meanwhile, there may be a case where, since the coupling measurement circuit 20 has passing loss β and an electrical length θ, the passing loss and the passing phase shift amount at the time when the high-frequency signal passes through the coupling measurement circuit 20 cannot be reduced to such an extent that the coupling signal at the reference surface A and the coupling signal at the reference surface B can be regarded as identical.

In that case, the susceptance value B₁, which is the reciprocal of the reactance value in the first and second variable reactance circuits 11 and 12 at which the coupled amplitude between the first input/output port 1 and the third input/output port 3 becomes zero, is expressed by the following formula (4).

$${B}_{1} = \frac{{Y}_{0} \{ sin ( φ - θ ) \pm 1 \}}{cos ( φ + θ )} \qquad ( 4 )$$

Further, the susceptance value B₂, which is the reciprocal of the reactance value in the third variable reactance circuit 13 at which the coupled amplitude between the first input/output port 1 and the third input/output port 3 becomes zero, is expressed by the following formula (5).

$${B}_{2} = - \frac{α β {Y}_{0} \{ sin ( φ - θ ) \pm 1 \}}{1 + {α}^{2} {β}^{2}} \qquad ( 5 )$$

Next, when the transmitter applies a high-frequency signal, which is a communication signal, to the first input/output port 1, the high-frequency signal pass through the first variable reactance circuit 11 in the variable decoupling circuit 10 to reach the first coupler 21 of the coupling measurement circuit 20.

The first coupler 21 of the coupling measurement circuit 20 outputs the reached high-frequency signal to the antenna 2, extracts a part of the high-frequency signal, and outputs the extracted high-frequency signal S₁ to the quadrature detector 23.

As a result, the high-frequency signal is emitted from the antenna 2 into space as a radio wave.

Among the power emitted from the antenna 2, a coupling signal S₂₁, which is power obtained by observing the power received by the antenna 4 at the reference surface A, reaches the second coupler 22 of the coupling measurement circuit 20 as a high-frequency signal.

The second coupler 22 of the coupling measurement circuit 20 outputs the reached high-frequency signal to the second variable reactance circuit 12 of the variable decoupling circuit 10, extracts a part of the high-frequency signal, and outputs the extracted high-frequency signal S₂ to the quadrature detector 23.

In order to simplify the description, characteristics of the first coupler 21 and the second coupler 22 are assumed to be the same in the first embodiment. Assuming that the high-frequency signals S₁ and S₂ are normalized by the amplitude of the high-frequency signal S₁, they are expressed by the following formulae (6) and (7).

S₁=sin(ωt) (6)

S₂=α sin(ωt+ϕ) (7)

The amplitude of the high-frequency signal S₁ is a known value as it is dependent on the high-frequency signal supplied from the transmitter to the first input/output port 1.

The quadrature detector 23 of the coupling measurement circuit 20 detects the I component and the Q component from the high-frequency signal S₁, which is the output signal of the first coupler 21, and the high-frequency signal S₂, which is the output signal of the second coupler 22.

When the I component and the Q component are detected, the quadrature detector 23 outputs the DC voltage Vᵢ indicating the I component as expressed by the following formula (8) to the A/D converter 24, and outputs the DC voltage V_{q} indicating the Q component as expressed by the following formula (9) to the A/D converter 25.

$$\begin{matrix}{V}_{i} = \frac{α}{2} sin φ & ( 8 ) \\ {V}_{q} = \frac{α}{2} cos φ & ( 9 )\end{matrix}$$

Upon reception of the DC voltage Vᵢ from the quadrature detector 23, the A/D converter 24 of the coupling measurement circuit 20 converts the DC voltage Vᵢ from an analog signal to a digital signal Dᵢ, and outputs the digital signal Dᵢ to the computing processor 26.

Upon reception of the DC voltage V_{q} from the quadrature detector 23, the A/D converter 25 of the coupling measurement circuit 20 converts the DC voltage V_{q} from an analog signal to a digital signal D_{q}, and outputs the digital signal D_{q} to the computing processor 26.

The computing processor 26 of the coupling measurement circuit 20 computes the coupled amplitude α and the coupled phase φ between the antenna 2 and the antenna 4 from the digital signal Dᵢ output from the A/D converter 24 and the digital signal D_{q} output from the A/D converter 25 as expressed by the following formulae (10) and (11), and outputs the coupled amplitude α and the coupled phase φ to the controller 30.

α=2\sqrt{Dᵢ²+D_{q}²} (10)

$$φ = {tan}^{- 1} \frac{Dq}{Di} \qquad ( 11 )$$

The CPU 32 of the controller 30 refers to the table stored in the memory 31, and obtains the reactance values of the first variable reactance circuit 11, the second variable reactance circuit 12, and the third variable reactance circuit 13 corresponding to the coupled amplitude α and the coupled phase φ output from the computing processor 26 of the coupling measurement circuit 20.

The CPU 32 then controls the reactance values of the first variable reactance circuit 11, the second variable reactance circuit 12, and the third variable reactance circuit 13 such that the reactance values of the first variable reactance circuit 11, the second variable reactance circuit 12, and the third variable reactance circuit 13 become the obtained reactance values.

Although an exemplary case where the CPU 32 refers to the table stored in the memory 31 to obtain the reactance value corresponding to the coupled amplitude α and the coupled phase φ output from the computing processor 26 is described here, it is not limited to this case, and may be as follows.

For example, when the passing loss and the passing phase shift amount at the time when the high-frequency signal passes through the coupling measurement circuit 20 can be reduced to such an extent that the coupling signal at the reference surface A and the coupling signal at the reference surface B can be regarded as identical, the CPU 32 substitutes the coupled phase φ into formula (2), and substitutes the coupled amplitude α and the coupled phase φ into formula (3).

In this manner, the CPU 32 calculates the susceptance value B₁ of the first variable reactance circuit 11 and the second variable reactance circuit 12, and the susceptance value B₂ of the third variable reactance circuit 13.

The CPU 32 then calculates a reactance value 1/B₁ of the first variable reactance circuit 11 and the second variable reactance circuit 12 from the susceptance value B₁ of the first variable reactance circuit 11 and the second variable reactance circuit 12.

Furthermore, the CPU 32 calculates a reactance value 1/B₂ of the third variable reactance circuit 13 from the susceptance value B₂ of the third variable reactance circuit 13.

For example, when the passing loss and the passing phase shift amount at the time when the high-frequency signal passes through the coupling measurement circuit 20 cannot be reduced to such an extent that the coupling signal at the reference surface A and the coupling signal at the reference surface B can be regarded as identical, the CPU 32 substitutes the coupled phase φ into formula (4), and substitutes the coupled amplitude α and the coupled phase φ into formula (5).

In this manner, the CPU 32 calculates the susceptance value B₁ of the first variable reactance circuit 11 and the second variable reactance circuit 12, and the susceptance value B₂ of the third variable reactance circuit 13.

The CPU 32 then calculates a reactance value 1/B₁ of the first variable reactance circuit 11 and the second variable reactance circuit 12 from the susceptance value B₁ of the first variable reactance circuit 11 and the second variable reactance circuit 12.

Furthermore, the CPU 32 calculates a reactance value 1/B₂ of the third variable reactance circuit 13 from the susceptance value B₂ of the third variable reactance circuit 13.

It is not necessary to refer to the table when the CPU 32 calculates the reactance value 1/B₁ of the first variable reactance circuit 11 and the second variable reactance circuit 12 and the reactance value 1/B₂ of the third variable reactance circuit 13 using formulae (2) and (3) or formulae (4) and (5).

As apparent from the above, according to the first embodiment, it is provided with: the variable decoupling circuit 10 to reduce coupling between the first input/output port 1 and the third input/output port 3, which is connected to each of the first input/output port and the third input/output port; and the coupling measurement circuit 20 to measure the coupled amplitude and the coupled phase between the second input/output port and the fourth input/output port from signals output from the variable decoupling circuit 10 to the second input/output port when a signal is input from the first input/output port 1 and signals output from the fourth input/output port to the variable decoupling circuit 10 when a signal is input from the fourth input/output port, and the controller 30 controls the variable decoupling circuit 10 in accordance with the coupled amplitude α and the coupled phase φ measured by the coupling measurement circuit 20 such that the coupled amplitude between the first input/output port 1 and the third input/output port 3 becomes zero, whereby an effect of being capable of suppressing coupling between the first input/output port 1 and the third input/output port 3 is exerted without executing processing of selecting a reactance element to be used from a large number of reactance elements.

### Second Embodiment

Although the exemplary case where the coupling measurement circuit 20 includes the quadrature detector 23 and the like is described in the first embodiment, in a second embodiment, an exemplary case where a coupling measurement circuit 20 does not include a quadrature detector 23 will be described.

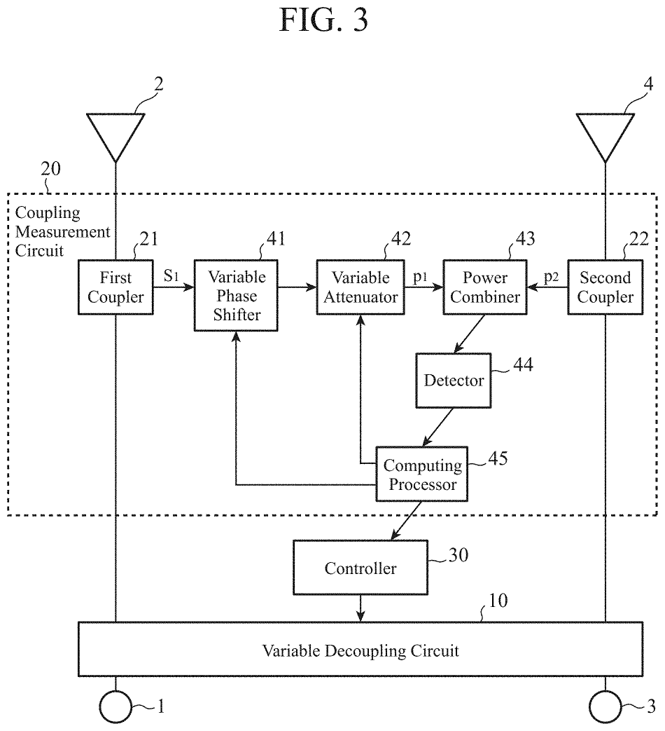

FIG. 3 is a configuration diagram illustrating a decoupling circuit according to the second embodiment of the present invention. In FIG. 3, the same reference signs as those in FIG. 1 indicate the same or corresponding parts, and descriptions thereof will be omitted.

A variable phase shifter 41 adjusts a phase of a high-frequency signal extracted by a first coupler 21, and outputs the high-frequency signal having been subject to the phase adjustment to a variable attenuator 42.

The variable attenuator 42 attenuates the amplitude of the high-frequency signal output from the variable phase shifter 41, and outputs the high-frequency signal having been subject to the amplitude attenuation to a power combiner 43.

The power combiner 43 combines the high-frequency signal whose amplitude is attenuated by the variable attenuator 42 and a high-frequency signal extracted by a second coupler 22, and outputs the combined high-frequency signal to a detector 44.

The detector 44 detects the high-frequency signal combined by the power combiner 43.

A computing processor 45 controls a phase shift amount Ψ, which is the amount of adjustment of the phase by the variable phase shifter 41, and an attenuation amount Dₐₜₜ of the variable attenuator 42 such that a signal detected by the detector 44 becomes zero.

Further, the computing processor 45 computes a coupled amplitude α and a coupled phase φ between an antenna 2 and an antenna 4 from the attenuation amount Dₐₜₜ and the phase shift amount Ψ at which the signal detected by the detector 44 becomes zero, and outputs the computed coupled amplitude α and the coupled phase φ to a controller 30.

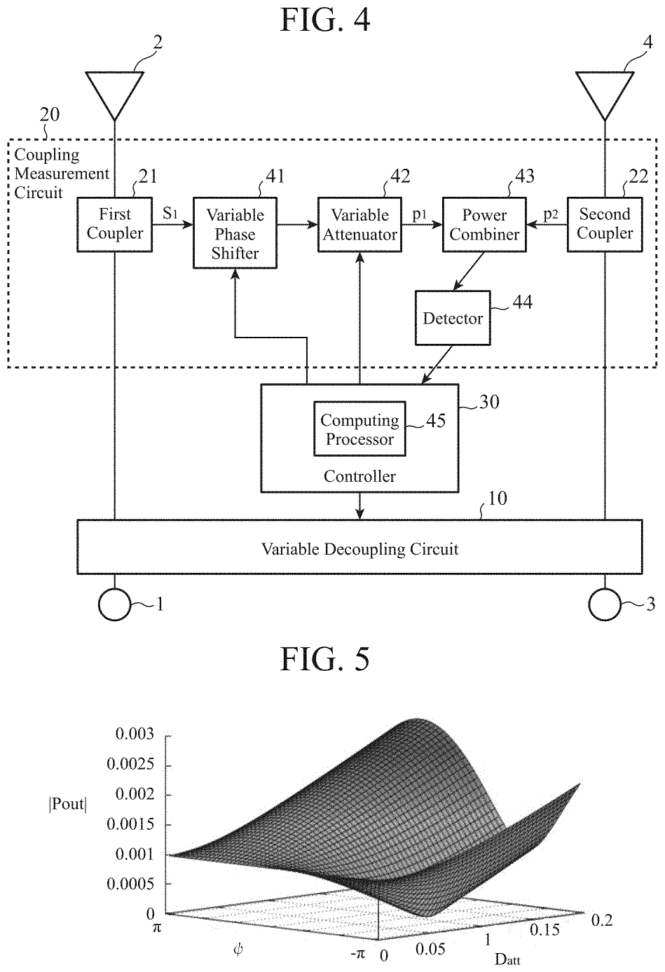

Although an exemplary case where the coupling measurement circuit 20 includes the computing processor 45 is illustrated in FIG. 3, the computing processor 45 may be included in the controller 30 as illustrated in FIG. 4.

FIG. 4 is a configuration diagram illustrating another decoupling circuit according to the second embodiment of the present invention.

Next, operation will be described.

Since the operation is similar to that of the first embodiment except for the coupling measurement circuit 20, only the operation of the coupling measurement circuit 20 will be described here.

The first coupler 21 of the coupling measurement circuit 20 outputs the high-frequency signal output from a first variable reactance circuit 11 of a variable decoupling circuit 10 to the antenna 2, extracts a part of the high-frequency signal, and outputs an extracted high-frequency signal S₁ to the variable phase shifter 41.

Upon reception of the high-frequency signal S₁ from the first coupler 21, the variable phase shifter 41 of the coupling measurement circuit 20 adjusts the phase of the high-frequency signal S₁, and outputs the high-frequency signal having been subject to the phase adjustment to the variable attenuator 42.

Upon reception of the high-frequency signal having been subject to the phase adjustment from the variable phase shifter 41, the variable attenuator 42 of the coupling measurement circuit 20 attenuates the amplitude of the high-frequency signal having been subject to the phase adjustment, and outputs a high-frequency signal p₁ having been subject to the amplitude attenuation to the power combiner 43.

The second coupler 22 of the coupling measurement circuit 20 outputs the high-frequency signal output from the antenna 4 to a second variable reactance circuit 12 of the variable decoupling circuit 10, extracts a part of the high-frequency signal, and outputs an extracted high-frequency signal S₂ to the power combiner 43 as a high-frequency signal p₂.

Here, it is assumed that a degree of coupling of the first coupler 21 and a degree of coupling of the second coupler 22 are the same, and the degree of coupling is Cₚ. Further, it is assumed that the coupling degree Cₚ and the attenuation amount Dₐₜₜ of the variable attenuator 42 are positive real numbers of zero to one.

The high-frequency signal p₁ output from the variable attenuator 42 to the power combiner 43 is expressed by the following formula (12) when normalized by the high-frequency signal output from the variable decoupling circuit 10 to the first coupler 21.

p₁=CₚDₐₜₜexp(jψ) (12)

In addition, the high-frequency signal p₂ output from the second coupler 22 to the power combiner 43 is expressed by the following formula (13) using the coupling signal S₂₁ expressed by formula (1).

p₂=Cₚ(1−Cₚ)αexp(jϕ) (13)

The power combiner 43 of the coupling measurement circuit 20 combines the high-frequency signal p₁ output from the variable attenuator 42 and the high-frequency signal p₂ output from the second coupler 22, and outputs a combined high-frequency signal pₒᵤₜ to the detector 44. The combined high-frequency signal pₒᵤₜ is expressed by the following formula (14).

pₒᵤₜ=CₚDₐₜₜ exp(jψ)+Cₚ(1−Cₚ)αexp(jϕ) (14)

The detector 44 of the coupling measurement circuit 20 receives the combined high-frequency signal pₒᵤₜ from the power combiner 43, detects the combined high-frequency signal pₒᵤₜ, and outputs the detected signal |pₒᵤₜ| to the computing processor 45. |pₒᵤₜ| is expressed by the following formula (15).

|pₒᵤₜ|²=Cₚ²{Dₐₜₜ²+(1−Cₚ)²α²+2Dₐₜₜ(1−Cₚ)α cos(ψ−ϕ)} (15)

The signal |pₒᵤₜ| detected by the detector 44 takes a minimum value of zero only when the following formulae (16) and (17) are satisfied except for the case where the amplitudes of the high-frequency signals p₁ and p₂ are zero, that is, Dₐₜₜ=0 and α=0.

Dₐₜₜ=(1−Cₚ)α (16)

ψ=ϕ±π (17)

The coupled amplitude α and the coupled phase φ can be uniquely determined from the attenuation amount Dₐₜₜ of the variable attenuator 42 and the phase shift amount Ψ of the variable phase shifter 41 at the time when the signal |pₒᵤₜ| detected by the detector 44 becomes the minimum value of zero.

FIG. 5 is an explanatory graph illustrating a change in |pₒᵤₜ| in the case where the coupling degree Cₚ=0.01, the coupled amplitude α=0.1, and the coupled phase φ=π/2.

In FIG. 5, in order to make the drawing easy to see, the range of the attenuation amount Dₐₜₜ is set to 0 to 0.2, and the range of the phase shift amount Ψ is set to −π to +π.

As it is apparent from FIG. 5, the signal |pₒᵤₜ| detected by the detector 44 becomes the minimum value of zero when the combination of the phase shift amount Ψ and the attenuation amount Dₐₜₜ is a specific combination, and is expressed by a unimodal function with the phase shift amount Ψ and the attenuation amount Dₐₜₜ as variables.

The computing processor 45 searches the phase shift amount Ψ of the variable phase shifter 41 and the attenuation amount Dₐₜₜ of the variable attenuator 42 at which the signal |pₒᵤₜ| becomes zero while monitoring the signal |pₒᵤₜ| detected by the detector 44.

When the computing processor 45 searches the phase shift amount Ψ and the attenuation amount Dₐₜₜ at which the signal |pₒᵤₜ| becomes zero, the computing processor 45 substitutes the signal |pₒᵤₜ| at which the attenuation amount Dₐₜₜ becomes zero into formula (16), thereby computing the coupled amplitude α between the antenna 2 and the antenna 4 to output the coupled amplitude α to the controller 30.

Further, the computing processor 45 computes the coupled phase φ between the antenna 2 and the antenna 4 by substituting the phase shift amount Ψ at which the signal |pₒᵤₜ| becomes zero into formula (17), and outputs the coupled phase φ to the controller 30.

The combination of the phase shift amount Ψ and the attenuation amount Dₐₜₜ at which the signal |pₒᵤₜ| becomes zero can be found by testing all combinations of the phase shift amount Ψ and the attenuation amount Dₐₜₜ while monitoring the signal |pₒᵤₜ| detected by the detector 44.

However, in consideration of the fact that the signal |pₒᵤₜ| is expressed by a unimodal function with the phase shift amount Ψ and the attenuation amount Dₐₜₜ as variables, the combination of the phase shift amount Ψ and the attenuation amount Dₐₜₜ at which the signal |pₒᵤₜ| becomes zero can be easily searched when the computing processor 45 uses a method of steepest descent as algorithm for minimizing the signal |pₒᵤₜ|.

Although an exemplary case where the method of steepest descent is used as the algorithm for minimizing the signal |pₒᵤₜ| is described here, it is not limited to the method of steepest descent, and it is apparent that another minimization algorithm may be used.

According to the second embodiment, the coupled amplitude α and the coupled phase φ between the antenna 2 and the antenna 4 can be measured without the coupling measurement circuit 20 including the quadrature detector 23 as illustrated in FIG. 2.

Since the quadrature detector 23 is a large-scale analog circuit including a plurality of mixers, there may be a case where the decoupling circuit including the quadrature detector 23 cannot be mounted in a communication device.

The decoupling circuit according to the second embodiment does not include the quadrature detector 23 that is a large-scale analog circuit, whereby it can be downsized compared with the decoupling circuit according to the first embodiment.

Although an exemplary case where a transmitter is connected to a first input/output port 1 and a receiver is connected to a third input/output port 3 is described in the second embodiment, the transmitter may be connected to the third input/output port 3, and the receiver may be connected to the first input/output port 1. However, in that case, it is necessary to switch the output destinations of the first coupler 21 and the second coupler 22 such that the output of the first coupler 21 is given to the power combiner 43, and the output of the second coupler 22 is given to the variable phase shifter 41 using, for example, a change-over switch.

### Third Embodiment

In the second embodiment, the exemplary case where the computing processor 45 searches the combination of the phase shift amount Ψ and the attenuation amount Dₐₜₜ at which the signal |pₒᵤₜ| becomes zero to compute the coupled amplitude α and the coupled phase φ between the antenna 2 and the antenna 4 is described.

In a third embodiment, an exemplary case where a computing processor 45 computes a coupled amplitude α and a coupled phase φ between an antenna 2 and an antenna 4 without searching a combination of a phase shift amount Ψ and an attenuation amount Dₐₜₜ at which a signal |pₒᵤₜ| becomes zero will be described.

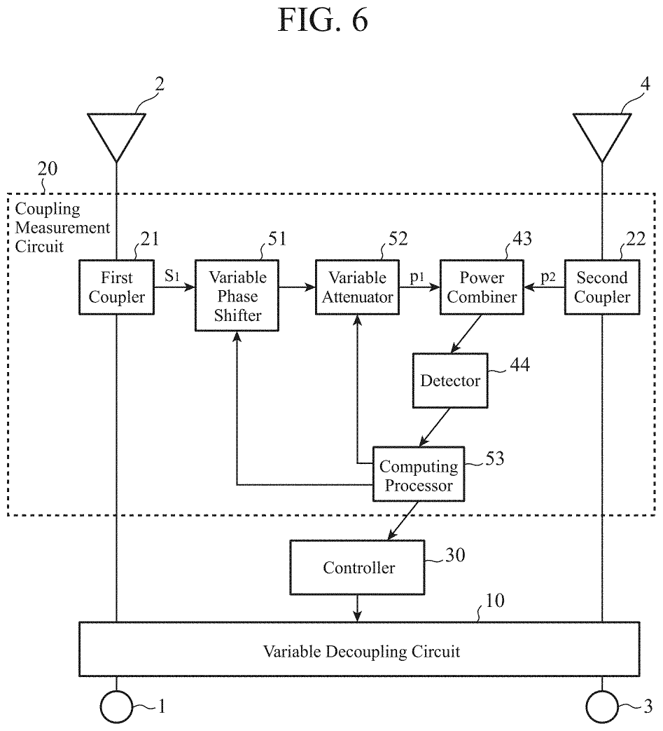

FIG. 6 is a configuration diagram illustrating a decoupling circuit according to the third embodiment of the present invention. In FIG. 6, the same reference signs as those in FIGS. 1 and 3 indicate the same or corresponding parts, and descriptions thereof will be omitted.

A variable phase shifter 51 is a binary variable phase shifter in which either a phase shift amount of 0 degrees or a phase shift amount of 90 degrees (π/2) is set as a phase shift amount Ψ, which shifts a phase of a high-frequency signal extracted by a first coupler 21 by the phase shift amount Ψ.

A variable attenuator 52 is a binary variable attenuator in which either an attenuation amount of zero or an attenuation amount for blocking a high-frequency signal is set as an attenuation amount Dₐₜₜ, which attenuates the amplitude of the high-frequency signal output from the variable phase shifter 51 by the attenuation amount Dₐₜₜ, and outputs the attenuated high-frequency signal to a power combiner 43.

A computing processor 53 obtains a signal |pₒᵤₜ| detected by a detector 44 while switching the phase shift amount Ψ of the variable phase shifter 51 and the attenuation amount Dₐₜₜ of the variable attenuator 52, and computes the coupled amplitude α and the coupled phase φ between the antenna 2 and the antenna 4 from each of the obtained signals |pₒᵤₜ|.

Although an exemplary case where a coupling measurement circuit 20 includes the computing processor 53 is illustrated in FIG. 6, the computing processor 53 may be included in a controller 30.

Next, operation will be described.

The signal |pₒᵤₜ| detected by the detector 44 is formulated as expressed by formula (15).

In formula (15), the phase shift amount Ψ and the attenuation amount Dₐₜₜ are variables, and the coupled amplitude α and the coupled phase φ are unknowns.

When the number of combinations of two variables (phase shift amount Ψ and attenuation amount Dₐₜₜ) at the time of detecting the signal |pₒᵤₜ| is equal to or more than three, two unknowns can be obtained. Therefore, the coupled amplitude α and the coupled phase φ can be calculated by measuring at least three signals |pₒᵤₜ|, whereby the coupled amplitude α and the coupled phase φ can be calculated more easily than the case of using the minimization algorithm.

Hereinafter, an exemplary case where three signals |pₒᵤₜ| are measured to calculate the coupled amplitude α and the coupled phase φ will be described.

(1) The computing processor 53 sets Dₐₜₜ=0 for the attenuation amount Dₐₜₜ, and sets Ψ=0 (or Ψ=π/2) for the phase shift amount Ψ. Dₐₜₜ=0 indicates that it is an attenuation amount for blocking a high-frequency signal.

In the case where the computing processor 53 sets Dₐₜₜ=0 and Ψ=0 (or Ψ=π/2), the signal |pₒᵤₜ| detected by the detector 44 is expressed by the following formula (18).

|pₒᵤₜ|²=Cₚ²(1−Cₚ)²α² (18)

In formula (18), a coupling degree Cₚ is known, whereby the coupled amplitude α can be obtained from formula (18).

(2) The computing processor 53 sets Dₐₜₜ=1 for the attenuation amount Dₐₜₜ, and sets Ψ=0 for the phase shift amount Ψ. Dₐₜₜ=1 indicates the attenuation amount of zero.

In the case where the computing processor 53 sets Dₐₜₜ=1 and Ψ=0, the signal |pₒᵤₜ| detected by the detector 44 is expressed by the following formula (19).

|pₒᵤₜ|²=Cₚ²{1+(1−Cₚ²α²+2(1−Cₚ)α cos(ϕ)} (19)

Since the coupled amplitude α has already been obtained, cos(φ) is obtained from formula (19).

(3) The computing processor 53 sets Dₐₜₜ=1 for the attenuation amount Dₐₜₜ, and sets Ψ=π/2 for the phase shift amount Ψ.

In the case where the computing processor 53 sets Dₐₜₜ=1 and Ψ=π/2, the signal |pₒᵤₜ| detected by the detector 44 is expressed by the following formula (20).

|pₒᵤₜ|²=Cₚ²{(1−Cₚ)²α²+2(1−Cₚ)α sin(ϕ)} (20)

Since the coupled amplitude α has already been obtained, sin(φ) is obtained from formula (20).

The computing processor 53 computes the coupled phase φ from the obtained cos(φ) and sin(φ).

According to the third embodiment, the amount of computing of the coupled amplitude α and the coupled phase φ performed by the computing processor 53 can be reduced compared with the case of the computing processor 45 according to the second embodiment in which the minimization algorithm is used. In addition, the circuit structure of the coupling measurement circuit 20 can be simplified, and the computing time can be shortened.

When three signals |pₒᵤₜ| are measured, the phase shift amount Ψ of the variable phase shifter 51 and the attenuation amount Dₐₜₜ of the variable attenuator 52 do not have to be set to continuous values. Therefore, the binary variable phase shifter is sufficient for the variable phase shifter 51, and the binary variable attenuator is sufficient for the variable attenuator 52.

### Fourth Embodiment

Although the exemplary case where the coupling measurement circuit 20 includes the quadrature detector 23 and the like is described in the first embodiment, in a fourth embodiment, an exemplary case where a coupling measurement circuit 20 does not include a quadrature detector 23 will be described.

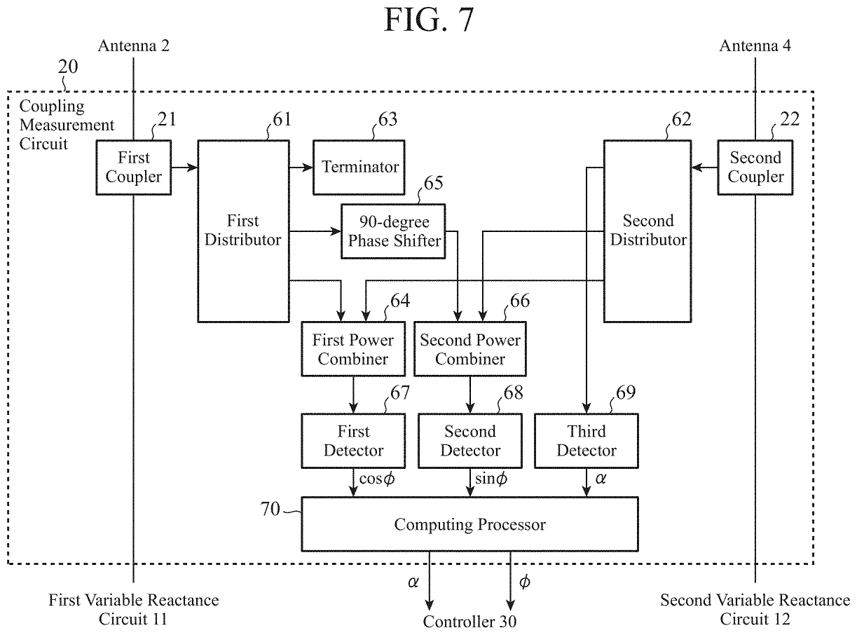

FIG. 7 is a configuration diagram illustrating the coupling measurement circuit 20 of a decoupling circuit according to the fourth embodiment of the present invention. In FIG. 7, the same reference signs as those in FIG. 2 indicate the same or corresponding parts, and descriptions thereof will be omitted. The overall configuration of the decoupling circuit is illustrated in FIG. 1 in a similar manner to the first embodiment.

A first distributor 61 equally divides the high-frequency signal extracted by a first coupler 21 into three, and outputs the respective three high-frequency signals to a terminator 63, a first power combiner 64, and a 90-degree phase shifter 65.

A second distributor 62 equally divides the high-frequency signal extracted by a second coupler 22 into three, and outputs the respective three high-frequency signals to the first power combiner 64, a second power combiner 66, and a third detector 69.

The terminator 63 consumes the high-frequency signal output from the first distributor 61 without reflecting it.

The first power combiner 64 combines the high-frequency signal distributed by the first distributor 61 with the high-frequency signal distributed by the second distributor 62, and outputs the combined high-frequency signal to a first detector 67.

The 90-degree phase shifter 65 shifts the phase of the high-frequency signal distributed by the first distributor 61 by 90 degrees, and outputs the high-frequency signal having been subject to the 90-degree phase shift to the second power combiner 66.

The second power combiner 66 combines the high-frequency signal having been subject to the 90-degree phase shift performed by the 90-degree phase shifter 65 with the high-frequency signal distributed by the second distributor 62, and outputs the combined high-frequency signal to a second detector 68.

The first detector 67 detects the high-frequency signal combined by the first power combiner 64, and outputs the detected signal to a computing processor 70.

The second detector 68 detects the high-frequency signal combined by the second power combiner 66, and outputs the detected signal to the computing processor 70.

The third detector 69 detects the high-frequency signal distributed by the second distributor 62, and outputs the detected signal to the computing processor 70.

The computing processor 70 computes a coupled amplitude α and a coupled phase φ between an antenna 2 and an antenna 4 from the signals detected by the first detector 67, the second detector 68, and the third detector 69, and outputs the computed coupled amplitude α and the computed coupled phase φ to a controller 30.

Next, operation will be described.

Since the operation is similar to that of the first embodiment except for the coupling measurement circuit 20, only the operation of the coupling measurement circuit 20 will be described here.

The first coupler 21 of the coupling measurement circuit 20 outputs the high-frequency signal output from a first variable reactance circuit 11 of a variable decoupling circuit 10 to the antenna 2, extracts a part of the high-frequency signal, and outputs the extracted high-frequency signal to the first distributor 61.

The second coupler 22 of the coupling measurement circuit 20 outputs the high-frequency signal output from the antenna 4 to the second variable reactance circuit 12 of the variable decoupling circuit 10, extracts a part of the high-frequency signal, and outputs the extracted high-frequency signal to the second distributor 62.

Upon reception of the high-frequency signal from the first coupler 21, the first distributor 61 equally divides the high-frequency signal into three, and outputs the respective three high-frequency signals to the terminator 63, the first power combiner 64, and the 90-degree phase shifter 65.

Upon reception of the high-frequency signal from the first distributor 61, the 90-degree phase shifter 65 shifts the phase of the high-frequency signal by 90 degrees, and outputs the high-frequency signal having been subject to the 90-degree phase shift to the second power combiner 66.

The first power combiner 64 combines the high-frequency signal distributed by the first distributor 61 with the high-frequency signal distributed by the second distributor 62, and outputs the combined high-frequency signal to the first detector 67.

The second power combiner 66 combines the high-frequency signal having been subject to the 90-degree phase shift performed by the 90-degree phase shifter 65 with the high-frequency signal distributed by the second distributor 62, and outputs the combined high-frequency signal to the second detector 68.

The first detector 67 detects the combined high-frequency signal output from the first power combiner 64, and outputs the detected signal to the computing processor 70.

The second detector 68 detects the combined high-frequency signal output from the second power combiner 66, and outputs the detected signal to the computing processor 70.

The third detector 69 detects the high-frequency signal distributed by the second distributor 62, and outputs the detected signal to the computing processor 70.

The computing processor 70 computes the coupled amplitude α and the coupled phase φ between the antenna 2 and the antenna 4 from the signals detected by the first detector 67, the second detector 68, and the third detector 69, and outputs the computed coupled amplitude α and the coupled phase φ to the controller 30.

Here, the high-frequency signal output from the second coupler 22 to the second distributor 62 is a signal dependent on a coupling degree Cₚ, the coupled amplitude α, and the coupled phase φ of the first coupler 21 and the second coupler 22.

The high-frequency signal combined by the first power combiner 64 is a signal dependent on the coupling degree Cₚ of the first coupler 21 and the second coupler 22 and a cosine (cos φ) of the coupled amplitude α and the coupled phase φ.

Further, the high-frequency signal combined by the second power combiner 66 is a signal dependent on the coupling degree Cₚ of the first coupler 21 and the second coupler 22 and a sine (sin φ) of the coupled amplitude α and the coupled phase φ.

Accordingly, in a similar manner to the computing processor 53 of FIG. 6 in which the attenuation amount Dₐₜₜ=1 and the phase shift amount Ψ=π/2 are set, the computing processor 70 can obtain the coupled amplitude α from the signal detected by the third detector 69.

Further, in a similar manner to the computing processor 53 of FIG. 6 in which the attenuation amount Dₐₜₜ=1 and the phase shift amount Ψ=0 are set, the computing processor 70 can obtain the cosine (cos φ) of the coupled phase p from the signal detected by the first detector 67.

Furthermore, in a similar manner to the computing processor 53 of FIG. 6 in which the attenuation amount Dₐₜₜ=1 and the phase shift amount Ψ=π/2 are set, the computing processor 70 can obtain the sine (sin φ) of the coupled phase p from the signal detected by the second detector 68.

The computing processor 70 computes the coupled phase φ from the cos(φ) and sin(φ) in a similar manner to the computing processor 53 of FIG. 6.

According to the fourth embodiment, the coupled amplitude α and the coupled phase φ between the antenna 2 and the antenna 4 can be measured without the coupling measurement circuit 20 including the quadrature detector 23 as illustrated in FIG. 2.

Further, according to the fourth embodiment, the circuit can be configured with all fixed passive circuits without the coupling measurement circuit 20 using the variable phase shifter 41 (or 51) and the variable attenuator 42 (or 52) as illustrated in FIGS. 3, 4, and 6. Furthermore, it is not necessary to control the phase shift amount of the variable phase shifter 41 (or 51) and the attenuation amount of the variable attenuator 42 (or 52), whereby the measurement time of the coupled amplitude α and the coupled phase φ can be shortened, and a processing load on the computing processor 70 can be reduced.

Although an exemplary case where the 90-degree phase shifter 65 shifts the phase of the high-frequency signal output from the first distributor 61 by 90 degrees and outputs the high-frequency signal having been subject to the 90-degree phase shift to the second power combiner 66 is described in the fourth embodiment, it is not limited to this case. For example, the 90-degree phase shifter 65 may shift the phase of the high-frequency signal output from the second distributor 62 by 90 degrees and output the high-frequency signal having been subject to the 90-degree phase shift to the second power combiner 66.

Although an exemplary case where the coupling measurement circuit 20 includes the terminator 63 is described in the fourth embodiment, it is not limited to this case. For example, the coupling measurement circuit 20 may not include the terminator 63, and the first distributor 61 may be a two-part distributing circuit. In that case, an attenuator may be included or the coupling degree of the first coupler 21 may be reduced such that the power of the high-frequency signal output from the first distributor 61 to the first power combiner 64 is equal between the case where the terminator 63 is included and the case where the terminator 63 is not included, and that the power of the high-frequency signal output from the 90-degree phase shifter 65 to the second power combiner 66 is equal between the case where the terminator 63 is included and the case where the terminator 63 is not included.

### Fifth Embodiment

In the first to fourth embodiments described above, an exemplary case where a variable decoupling circuit 10 includes a first variable reactance circuit 11, a second variable reactance circuit 12, and a third variable reactance circuit 13 has been described.

In a fifth embodiment, an exemplary case where the variable decoupling circuit 10 includes a first coupler 81, a variable phase shifter 82, a variable attenuator 83, and a second coupler 84 will be described.

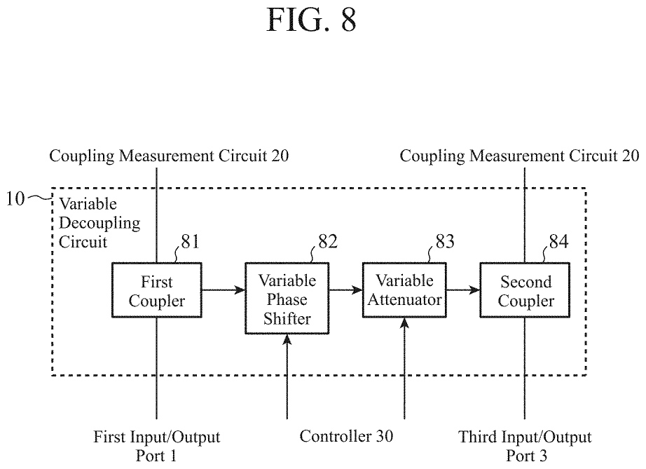

FIG. 8 is a configuration diagram illustrating the variable decoupling circuit 10 of a decoupling circuit according to the fifth embodiment of the present invention. The overall configuration of the decoupling circuit is illustrated in FIG. 1 in a similar manner to the first embodiment.

In FIG. 8, when outputting high-frequency signal input from a first input/output port 1 to a coupling measurement circuit 20, the first coupler 81 extracts a part of the high-frequency signal and output it to the variable phase shifter 82.

The variable phase shifter 82 adjusts the phase of the high-frequency signal output from the first coupler 81, and outputs the high-frequency signal having been subject to the phase adjustment to the variable attenuator 83.

The variable attenuator 83 attenuates the amplitude of the high-frequency signal having been subject to the phase adjustment output from the variable phase shifter 82, and outputs the high-frequency signal having been subject to the amplitude attenuation to the second coupler 84.

The second coupler 84 combines the high-frequency signal having been subject to the amplitude attenuation output from the variable attenuator 83 with the high-frequency signal output from the coupling measurement circuit 20, and outputs the combined high-frequency signal to a third input/output port 3.

In the fifth embodiment as well, in a similar manner to the first to fourth embodiments described above, a controller 30 controls the variable decoupling circuit 10 such that the coupled amplitude between the first input/output port 1 and the third input/output port 3 becomes zero in accordance with a coupled amplitude α and a coupled phase φ measured by the coupling measurement circuit 20.

However, the fifth embodiment is different from the first to fourth embodiments described above in that the controller 30 controls a phase shift amount, which is an amount of phase adjustment performed by the variable phase shifter 82, and an attenuation amount of the variable attenuator 83 without controlling reactance values of the first variable reactance circuit 11, the second variable reactance circuit 12, and the third variable reactance circuit 13.

Next, operation will be described.

Note that the operation of the coupling measurement circuit 20 is similar to that in the first to fourth embodiments, and detailed description thereof will be omitted.

In the fifth embodiment as well, description will be made on the assumption that a transmitter is connected to the first input/output port 1 and a receiver is connected to the third input/output port 3.

When the transmitter applies high-frequency signal, which is a communication signal, to the first input/output port 1, the first coupler 81 in the variable decoupling circuit 10 outputs the high-frequency signal to the coupling measurement circuit 20, extracts a part of the high-frequency signal, and outputs the extracted high-frequency signal to the variable phase shifter 82.

The high-frequency signal output from the first coupler 81 in the variable decoupling circuit 10 to the coupling measurement circuit 20 is emitted from an antenna 2 into space as a radio wave, in a similar manner to the first to fourth embodiments described above.

A part of the radio wave emitted from the antenna 2 is received by an antenna 4, and a coupling signal, which is the radio wave received by the antenna 4, reaches the second coupler 84 in the variable decoupling circuit 10 as a high-frequency signal.

The variable phase shifter 82 of the variable decoupling circuit 10 adjusts the phase of the high-frequency signal output from the first coupler 81 by the phase shift amount set by the controller 30, and outputs the high-frequency signal having been subject to the phase adjustment to the variable attenuator 83.

The variable attenuator 83 of the variable decoupling circuit 10 attenuates the amplitude of the high-frequency signal having been subject to the phase adjustment output from the variable phase shifter 82 by the attenuation amount set by the controller 30, and outputs the high-frequency signal having been subject to the amplitude attenuation to the second coupler 84.

The second coupler 84 in the variable decoupling circuit 10 combines the high-frequency signal having been subject to the amplitude attenuation output from the variable attenuator 83 with the high-frequency signal output from the coupling measurement circuit 20, and outputs the combined high-frequency signal to the third input/output port 3.

Here, when the high-frequency signal having been subject to the amplitude attenuation output from the variable attenuator 83 and the high-frequency signal output from the coupling measurement circuit 20 are equal in amplitude to each other and opposed in phase to each other (hereinafter referred to as “equal amplitude reverse phase”), the two high-frequency signal cancel each other, and the high-frequency signal combined by the second coupler 84 is not output to the third input/output port 3.

That is, the coupled amplitude between the first input/output port 1 and the third input/output port 3 becomes zero.

When the coupling measurement circuit 20 measures the coupled amplitude α and the coupled phase φ, the controller 30 controls the phase shift amount of the variable phase shifter 82 such that the coupled amplitude between the first input/output port 1 and the third input/output port 3 becomes zero in accordance with the coupled amplitude α and the coupled phase φ measured by the coupling measurement circuit 20.

The controller 30 further controls the attenuation amount of the variable attenuator 83 such that the coupled amplitude between the first input/output port 1 and the third input/output port 3 becomes zero.

When the high-frequency signal after the amplitude attenuation output from the variable attenuator 83 and the high-frequency signal output from the coupling measurement circuit 20 become the equal amplitude reverse phase as a result of the control of the phase shift amount and the attenuation amount performed by the controller 30, the coupled amplitude between the first input/output port 1 and the third input/output port 3 becomes zero.

As apparent from the above, according to the fifth embodiment, even in the case where the variable decoupling circuit 10 includes the first coupler 81, the variable phase shifter 82, the variable attenuator 83, and the second coupler 84, in a similar manner to the first to fourth embodiments, an effect of being capable of suppressing coupling between a second input/output port and a fourth input/output port is exerted without executing processing of selecting a reactance element to be used from a large number of reactance elements.

In the configuration in which the variable decoupling circuit 10 includes the first variable reactance circuit 11, the second variable reactance circuit 12, and the third variable reactance circuit 13 as in the first to fourth embodiments described above, states of the first variable reactance circuit 11, the second variable reactance circuit 12, and the third variable reactance circuit 13 may change. As the state changes, the impedance matching state changes between the first input/output port 1 and the third input/output port 3 and the variable decoupling circuit 10.

In view of the above, it is preferable to provide a variable matching circuit between the first input/output port 1 and the third input/output port 3 and the variable decoupling circuit 10 to suppress the coupling between the antenna 2 and the antenna 4 even when the states of the first variable reactance circuit 11, the second variable reactance circuit 12, and the third variable reactance circuit 13 change.

However, in the fifth embodiment, even when states of the variable phase shifter 82 and variable attenuator 83 included in the variable decoupling circuit 10 change, an influence on the impedance matching state between the first input/output port 1 and the third input/output port 3 and the variable decoupling circuit 10 is slight. The reason for the slight influence is that the connection is made through the first coupler 81 and the second coupler 84.

Therefore, in the fifth embodiment, it is possible to obtain the effect that it is not necessary to provide a variable decoupling circuit between the first input/output port 1 and the third input/output port 3 and the variable decoupling circuit 10.

Further, while the coupling between the antenna 2 and the antenna 4 differs depending on the frequency of the radio wave transmitted/received by the antennas 2 and 4, by making the variable phase shifter 82 and the variable attenuator 83 included in the variable decoupling circuit 10 to have frequency characteristics, it becomes possible to suppress the coupling between the antenna 2 and the antenna 4 over a wide range of frequencies.

Although the decoupling circuit capable of suppressing the coupling between the antenna 2 and the antenna 4 are exemplified in the first to fifth embodiments, it is not limited to this case, and it is also possible to suppress coupling between equal to or more than three antennas.

In the case of suppressing the coupling between equal to or more than three antennas, the variable decoupling circuit 10 and the coupling measurement circuit 20 may be provided between respective antennas, the coupling measurement circuit 20 may measure a coupled amplitude and a coupled phase between the antennas for each pair of the antennas, and the controller 30 may control the variable decoupling circuit 10 in accordance with the coupled amplitude and the coupled phase measured by the coupling measurement circuit 20 such that the coupled amplitude between the first input/output port 1 and the third input/output port 3 becomes zero.

Note that, in the present invention, the respective embodiments can be freely combined, an arbitrary constituent element of each embodiment can be modified, and an arbitrary constituent element of each embodiment can be omitted within the scope of the invention.

### INDUSTRIAL APPLICABILITY

The present invention is suitable for a decoupling circuit that reduces coupling between a plurality of input/output ports.

### REFERENCE SIGNS LIST

1 first input/output port
2 antenna (second input/output port)
3 third input/output port
4 antenna (fourth input/output port)
10 variable decoupling circuit
11 first variable reactance circuit
12 second variable reactance circuit
13 variable reactance circuit
20 coupling measurement circuit
21 first coupler
22 second coupler
23 quadrature detector
24, 25 A/D converter
26 computing processor
30 controller
31 memory
32 CPU
41 variable phase shifter
42 variable attenuator
43 power combiner
44 detector
45 computing processor
51 variable phase shifter
52 variable attenuator
53 computing processor
61 first distributor
62 second distributor
63 terminator
64 first power combiner
65 90-degree phase shifter
66 second power combiner
67 first detector
68 second detector
69 third detector
70 computing processor
81 first coupler
82 variable phase shifter
83 variable attenuator
84 second coupler

1-13. (canceled)

14. A decoupling circuit comprising:
a variable decoupling circuit to reduce coupling between a first input/output port and a third input/output port, the variable decoupling circuit being connected to each of the first input/output port and the third input/output port;
a coupling measurement circuit to measure a coupled amplitude and a coupled phase between a second input/output port and a fourth input/output port from a signal output from the variable decoupling circuit to the second input/output port when a signal is input from the first input/output port and a signal output from the fourth input/output port to the variable decoupling circuit when a signal is input from the fourth input/output port; and
a controller to control the variable decoupling circuit in accordance with the coupled amplitude and the coupled phase measured by the coupling measurement circuit such that a coupled amplitude between the first input/output port and the third input/output port becomes zero, wherein
the coupling measurement circuit includes:
a first coupler to extract a part of the signal output from the variable decoupling circuit to the second input/output port;
a second coupler to extract a part of the signal output from the fourth input/output port to the variable decoupling circuit;
a quadrature detector to detect an in-phase component and a quadrature component from a signal extracted by the first coupler and a signal extracted by the second coupler; and
a computing processor to compute the coupled amplitude and the coupled phase between the second input/output port and the fourth input/output port from the in-phase component and the quadrature component detected by the quadrature detector.

15. A decoupling circuit comprising:
a variable decoupling circuit to reduce coupling between a first input/output port and a third input/output port, the variable decoupling circuit being connected to each of the first input/output port and the third input/output port;
a coupling measurement circuit to measure a coupled amplitude and a coupled phase between a second input/output port and a fourth input/output port from a signal output from the variable decoupling circuit to the second input/output port when a signal is input from the first input/output port and a signal output from the fourth input/output port to the variable decoupling circuit when a signal is input from the fourth input/output port; and
a controller to control the variable decoupling circuit in accordance with the coupled amplitude and the coupled phase measured by the coupling measurement circuit such that a coupled amplitude between the first input/output port and the third input/output port becomes zero, wherein
the coupling measurement circuit includes:
a first coupler to extract a part of the signal output from the variable decoupling circuit to the second input/output port;
a second coupler to extract a part of the signal output from the fourth input/output port to the variable decoupling circuit;
a variable phase shifter to adjust a phase of a signal extracted by the first coupler;
a variable attenuator to attenuate an amplitude of the signal the phase of which is adjusted by the variable phase shifter;
a power combiner to combine the signal the amplitude of which is attenuated by the variable attenuator with a signal extracted by the second coupler;
a detector to detect a signal combined by the power combiner; and
a computing processor to set a phase shift amount of the variable phase shifter and an attenuation amount of the variable attenuator, wherein the computing processor computes the coupled amplitude and the coupled phase between the second input/output port and the fourth input/output port from the phase shift amount of the variable phase shifter, the attenuation amount of the variable attenuator, and the signal detected by the detector.

16. A decoupling circuit comprising:
a variable decoupling circuit to reduce coupling between a first input/output port and a third input/output port, the variable decoupling circuit being connected to each of the first input/output port and the third input/output port;
a coupling measurement circuit to measure a coupled amplitude and a coupled phase between a second input/output port and a fourth input/output port from a signal output from the variable decoupling circuit to the second input/output port when a signal is input from the first input/output port and a signal output from the fourth input/output port to the variable decoupling circuit when a signal is input from the fourth input/output port; and
a controller to control the variable decoupling circuit in accordance with the coupled amplitude and the coupled phase measured by the coupling measurement circuit such that a coupled amplitude between the first input/output port and the third input/output port becomes zero, wherein
the coupling measurement circuit includes:
a first coupler to extract a part of the signal output from the variable decoupling circuit to the second input/output port;
a second coupler to extract a part of the signal output from the fourth input/output port to the variable decoupling circuit;
a first distributor to distribute a signal extracted by the first coupler;
a second distributor to distribute a signal extracted by the second coupler;
a first power combiner to combine the signal distributed by the first distributor with the signal distributed by the second distributor;
a 90-degree phase shifter to shift a phase of the signal distributed by the first distributor by 90 degrees;
a second power combiner to combine the signal the phase of which is sifted by 90 degrees by the 90-degree phase shifter with the signal distributed by the second distributor;
a first detector to detect the signal combined by the first power combiner;
a second detector to detect the signal combined by the second power combiner;
a third detector to detect the signal distributed by the second distributor; and
a computing processor to compute the coupled amplitude and the coupled phase between the second input/output port and the fourth input/output port from the signals detected by the first to third detectors.

17. The decoupling circuit according to claim 14, wherein
the variable decoupling circuit includes:
a first variable reactance circuit having one end connected to the first input/output port and the other end connected to the second input/output port via the coupling measurement circuit;
a second variable reactance circuit having one end connected to the third input/output port and the other end connected to the fourth input/output port via the coupling measurement circuit; and
a third variable reactance circuit having one end connected to the first input/output port and the other end connected to the third input/output port, and
the controller controls reactance values of the first to third variable reactance circuits in accordance with the coupled amplitude and the coupled phase measured by the coupling measurement circuit such that the coupled amplitude between the first input/output port and the third input/output port becomes zero.

18. The decoupling circuit according to claim 14, wherein
the variable decoupling circuit includes:
a first coupler to extract, at a time of outputting the signal input from the first input/output port to the coupling measurement circuit, a part of the input signal;
a variable phase shifter to adjust a phase of a signal extracted by the first coupler of the variable decoupling circuit;
a variable attenuator to attenuate an amplitude of the signal the phase of which is adjusted by the variable phase shifter of the variable decoupling circuit; and
a second coupler to couple the signal the amplitude of which is attenuated by the variable attenuator of the variable decoupling circuit and a signal input from the fourth input/output port and to output the coupled signal to the third input/output port, and
the controller controls a phase shift amount that is an amount of phase adjustment performed by the variable phase shifter of the variable decoupling circuit and an attenuation amount of the variable attenuator of the variable decoupling circuit in accordance with the coupled amplitude and the coupled phase measured by the coupling measurement circuit such that the coupled amplitude between the first input/output port and the third input/output port becomes zero.

19. The decoupling circuit according to claim 15, wherein
the computing processor in the coupling measurement circuit is included in the controller.

20. The decoupling circuit according to claim 15, wherein
the computing processor controls a phase shift amount that is an amount of phase adjustment performed by the variable phase shifter and an attenuation amount of the variable attenuator such that the signal detected by the detector becomes zero, and controls the coupled amplitude and the coupled phase between the second input/output port and the fourth input/output port from the phase shift amount and the attenuation amount at which the signal detected by the detector becomes zero.

21. The decoupling circuit according to claim 20, wherein
the processor computes the phase shift amount and the attenuation amount at which the signal detected by the detector becomes zero using a method of steepest descent.

22. The decoupling circuit according to claim 15, wherein
the variable phase shifter is a binary variable phase shifter set to either a phase shift amount of 0 degrees or a phase shift amount of 90 degrees,
the variable attenuator is a binary variable attenuator set to either an attenuation amount of zero or an attenuation amount for blocking the signal the phase of which is adjusted by the variable phase shifter, and
the computing processor obtains each signal detected by the detector while switching the phase shift amount of the variable phase shifter and the attenuation amount of the variable attenuator, and computes the coupled amplitude and the coupled phase between the second input/output port and the fourth input/output port from the obtained signal.

23. The decoupling circuit according to claim 17, wherein
the controller calculates a susceptance value B₁ that is a reciprocal of a reactance value in the first and second variable reactance circuits using the following formula, and control the reactance value of the first and second variable reactance circuits in accordance with the susceptance value B₁; and calculate a susceptance value B₂ that is a reciprocal of a reactance value in the third variable reactance circuit using the following formula, and control the reactance value of the third variable reactance circuit in accordance with the susceptance value B₂,
$${B}_{1} = \frac{{Y}_{0} ( sin φ \pm 1 )}{cos φ}$$
$${B}_{2} = - \frac{α {Y}_{0} ( sin φ \pm 1 )}{1 + {α}^{2}}$$
where Y0 represents a normalized admittance, α represents a coupled amplitude measured by the coupling measurement circuit, and φ represents a coupled phase measured by the coupling measurement circuit.

24. The decoupling circuit according to claim 17, wherein
the controller calculates a susceptance value B₁ that is a reciprocal of a reactance value in the first and second variable reactance circuits using the following formula, and control the reactance value of the first and second variable reactance circuits in accordance with the susceptance value B₁; and calculates a susceptance value B₂ that is a reciprocal of a reactance value in the third variable reactance circuit using the following formula, and control the reactance value of the third variable reactance circuit in accordance with the susceptance value B₂,
$${B}_{1} = \frac{{Y}_{0} \{ sin ( φ - θ ) \pm 1 \}}{cos ( φ + θ )}$$
$${B}_{2} = - \frac{α β {Y}_{0} \{ sin ( φ - θ ) \pm 1 \}}{1 + {a}^{2} {β}^{2}}$$
where Y0 represents a normalized admittance, α represents a coupled amplitude measured by the coupling measurement circuit, φ represents a coupled phase measured by the coupling measurement circuit, β represents passing loss in the coupling measurement circuit, and θ represents an electrical length in the coupling measurement circuit.

25. The decoupling circuit according to claim 18, wherein
the controller controls the phase shift amount of the variable phase shifter of the variable decoupling circuit and the attenuation amount of the variable attenuator of the variable decoupling circuit such that the signal the amplitude of which is attenuated by the variable attenuator of the variable decoupling circuit and a signal output from the fourth input/output port to the variable decoupling circuit are equal in amplitude to each other and opposed in phase to each other.

26. The decoupling circuit according to claim 15, wherein
the variable decoupling circuit includes:
a first variable reactance circuit having one end connected to the first input/output port and the other end connected to the second input/output port via the coupling measurement circuit;
a second variable reactance circuit having one end connected to the third input/output port and the other end connected to the fourth input/output port via the coupling measurement circuit; and
a third variable reactance circuit having one end connected to the first input/output port and the other end connected to the third input/output port, and
the controller controls reactance values of the first to third variable reactance circuits in accordance with the coupled amplitude and the coupled phase measured by the coupling measurement circuit such that the coupled amplitude between the first input/output port and the third input/output port becomes zero.

27. The decoupling circuit according to claim 15, wherein
the variable decoupling circuit includes:
a first coupler to extract, at a time of outputting the signal input from the first input/output port to the coupling measurement circuit, a part of the input signal;
a variable phase shifter to adjust a phase of a signal extracted by the first coupler of the variable decoupling circuit;
a variable attenuator to attenuate an amplitude of the signal the phase of which is adjusted by the variable phase shifter of the variable decoupling circuit; and
a second coupler to couple the signal the amplitude of which is attenuated by the variable attenuator of the variable decoupling circuit and a signal input from the fourth input/output port and outputting the coupled signal to the third input/output port, and
the controller controls a phase shift amount that is an amount of phase adjustment performed by the variable phase shifter of the variable decoupling circuit and an attenuation amount of the variable attenuator of the variable decoupling circuit in accordance with the coupled amplitude and the coupled phase measured by the coupling measurement circuit such that the coupled amplitude between the first input/output port and the third input/output port becomes zero.

28. The decoupling circuit according to claim 16, wherein
the variable decoupling circuit includes:
a first variable reactance circuit having one end connected to the first input/output port and the other end connected to the second input/output port via the coupling measurement circuit;
a second variable reactance circuit having one end connected to the third input/output port and the other end connected to the fourth input/output port via the coupling measurement circuit; and
a third variable reactance circuit having one end connected to the first input/output port and the other end connected to the third input/output port, and
the controller controls reactance values of the first to third variable reactance circuits in accordance with the coupled amplitude and the coupled phase measured by the coupling measurement circuit such that the coupled amplitude between the first input/output port and the third input/output port becomes zero.

29. The decoupling circuit according to claim 16, wherein
the variable decoupling circuit includes:
a first coupler to extract, at a time of outputting the signal input from the first input/output port to the coupling measurement circuit, a part of the input signal;
a variable phase shifter to adjust a phase of a signal extracted by the first coupler of the variable decoupling circuit;
a variable attenuator to attenuate an amplitude of the signal the phase of which is adjusted by the variable phase shifter of the variable decoupling circuit; and
a second coupler to couple the signal the amplitude of which is attenuated by the variable attenuator of the variable decoupling circuit and a signal input from the fourth input/output port and to output the coupled signal to the third input/output port, and
the controller controls a phase shift amount that is an amount of phase adjustment performed by the variable phase shifter of the variable decoupling circuit and an attenuation amount of the variable attenuator of the variable decoupling circuit in accordance with the coupled amplitude and the coupled phase measured by the coupling measurement circuit such that the coupled amplitude between the first input/output port and the third input/output port becomes zero.
